(19) United States
(12) Patent Application Publication
(10) Pub. No.: US 2023/0180294 A1
(43) Pub. Date: Jun. 8, 2023

(54) TECHNIQUES FOR SOFT CANCELLING UPLINK TRANSMISSION

(71) Applicant: QUALCOMM Incorporated, San Diego, CA (US)

(72) Inventors: Changlong XU, Beijing (CN); Xiaoxia ZHANG, San Diego, CA (US); Jing SUN, San Diego, CA (US); Aleksandar DAMNJANOVIC, Del Mar, CA (US); Andrei Dragos RADULESCU, La Jolla, CA (US); Mostafa KHOSHNEVISAN, San Diego, CA (US); Tao LUO, San Diego, CA (US); Juan MONTOJO, San Diego, CA (US); Wei YANG, San Diego, CA (US)

(21) Appl. No.: 17/906,305

(22) PCT Filed: Mar. 19, 2020
(86) PCT No.: PCT/CN2020/080115

§ 371 Date: Sep. 14, 2022

(51) Int. Cl. H04W 74/08; H04W 52/14; H04W 52/36; H04W 52/10; H04W 72/1268

(52) U.S. Cl. CPC H04W 74/0816; H04W 52/10; H04W 52/146; H04W 52/367; H04W 72/1268; H04W 74/0866

(57) ABSTRACT

Various aspects of the present disclosure generally relate to wireless communication. In some aspects, a user equipment may receive a cancellation indication associated with an uplink transmission on a shared radio frequency spectrum band, the shared radio frequency spectrum band having a listen-before-talk channel access mechanism to access the shared radio frequency spectrum band; determine, based at least in part on the reception of the cancellation indication associated with the uplink transmission on the shared radio frequency spectrum band, whether the uplink transmission is to be cancelled or transmitted at a reduced transmit power; and when the uplink transmission is to be transmitted at the reduced transmit power, transmitting the uplink transmission at the reduced transmit power. Numerous other aspects are provided.

### FIELD OF THE DISCLOSURE

Aspects of the present disclosure generally relate to wireless communication and to techniques and apparatuses for soft cancelling an uplink transmission.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment, may include receiving a cancellation indication associated with an uplink transmission on a shared radio frequency spectrum band, the shared radio frequency spectrum band having a listen-before-talk (LBT) channel access mechanism to access the shared radio frequency spectrum band; determining, based at least in part on the reception of the cancellation indication associated with the uplink transmission on the shared radio frequency spectrum band, whether the uplink transmission is to be cancelled or transmitted at a reduced transmit power; and when the uplink transmission is to be transmitted at the reduced transmit power, transmitting the uplink transmission at the reduced transmit power.

In some aspects, the uplink transmission is a first uplink transmission, and the first uplink transmission is transmitted at the reduced transmit power based at least in part on the UE being configured to transmit a second uplink transmission subsequent to the first uplink transmission.

In some aspects, the method includes transmitting the second uplink transmission without performing an LBT operation between the first uplink transmission and the second uplink transmission.

In some aspects, the determination is based at least in part on whether the uplink transmission overlaps another uplink transmission.

In some aspects, the uplink transmission is a first uplink transmission, and the first uplink transmission is cancelled based at least in part on a second uplink transmission of the UE being non-consecutive with the first uplink transmission.

In some aspects, the determination is based at least in part on receiving an indication of whether the uplink transmission is to be cancelled or transmitted at the reduced transmit power.

In some aspects, the indication is received in a grant associated with the uplink transmission.

In some aspects, when the uplink transmission is associated with a multi-transmission-time-interval (multi-TTI) grant, an uplink shared channel with slot aggregation, or an aperiodic reference signal, the method further comprises: cancelling a final TTI, repetition, or reference signal of the uplink transmission, and transmitting, at the reduced transmit power, one or more preceding TTIs, repetitions, or reference signals of the uplink transmission.

In some aspects, the reduced transmit power is selected based at least in part on the uplink transmission being associated with a periodic or semi-persistent reference signal.

In some aspects, the reduced transmit power is associated with an open-loop power control parameter that is applied for one or more symbols of the uplink transmission that are to be transmitted at the reduced transmit power.

In some aspects, the uplink transmission is a first uplink transmission that includes one or more overlapped symbols and one or more non-overlapped symbols relative to a second uplink transmission, the one or more overlapped symbols are associated with one or more first open-loop power control (OLPC) parameters, and the one or more non-overlapped symbols are associated with one or more second OLPC parameters.

In some aspects, the one or more first OLPC parameters comprise at least one of: an OLPC parameter associated with a symbol that is to use a higher transmit power than the reduced transmit power, an OLPC parameter associated with creating an LBT gap for another UE, or an OLPC parameter associated with avoiding a collision with the second uplink transmission.

In some aspects, a plurality of OLPC parameters, including the one or more first OLPC parameters, are applied for respective overlapped symbols including the one or more overlapped symbols.

In some aspects, when the uplink transmission is to be transmitted at the reduced transmit power, the cancellation indication is associated with a first processing timeline, and when the uplink transmission is to be cancelled, the cancellation indication is associated with a second processing timeline.

In some aspects, the method includes transmitting capability information of the UE, wherein the first processing timeline is based at least in part on the capability information.

In some aspects, when the cancellation indication is associated with a collision between the uplink transmission and a higher-priority transmission of the UE, a processing timeline of the higher-priority transmission is increased relative to a baseline processing timeline.

In some aspects, the method includes transmitting capability information of the UE, wherein the processing timeline is increased based at least in part on the capability information.

In some aspects, the cancellation indication is based at least in part on an overlap between the uplink transmission and a transmission by another UE.

In some aspects, the cancellation indication is based at least in part on an overlap between the uplink transmission and a higher-priority transmission by the UE.

In some aspects, a method of wireless communication, performed by a base station, may include transmitting, to a UE, a cancellation indication associated with an uplink transmission on a shared radio frequency spectrum band, the shared radio frequency spectrum band having an LBT channel access mechanism to access the shared radio frequency spectrum band; and when the uplink transmission is to be transmitted at the reduced transmit power, receiving the uplink transmission at the reduced transmit power.

In some aspects, the uplink transmission is a first uplink transmission, and the first uplink transmission is associated with the reduced transmit power based at least in part on the UE being configured to transmit a second uplink transmission subsequent to the first uplink transmission.

In some aspects, the method includes determining whether the uplink transmission is to be cancelled or transmitted at the reduced transmit power based at least in part on whether the uplink transmission overlaps with another uplink transmission.

In some aspects, the uplink transmission is a first uplink transmission, and the first uplink transmission is cancelled based at least in part on a second uplink transmission of the UE being non-consecutive with the first uplink transmission.

In some aspects, the method includes transmitting an indication of whether the uplink transmission is to be cancelled or transmitted at the reduced transmit power.

In some aspects, the indication is provided in a grant associated with the uplink transmission.

In some aspects, when the uplink transmission is associated with a multi-TTI grant, an uplink shared channel with slot aggregation, or an aperiodic reference signal, the method further comprises: determining that a final TTI, repetition, or reference signal of the uplink transmission is cancelled, and determining that one or more preceding TTIs, repetitions, or reference signals of the uplink transmission are associated with the reduced transmit power.

In some aspects, the reduced transmit power is selected based at least in part on the uplink transmission being associated with a periodic or semi-persistent reference signal.

In some aspects, the reduced transmit power is associated with an open-loop power control parameter that is associated with one or more symbols of the uplink transmission that are associated with the reduced transmit power.

In some aspects, the transmission of the cancellation indication is associated with reducing a transmit power of the UE so that a higher-priority UE can secure channel access.

In some aspects, the transmission of the cancellation indication is associated with reducing a transmit power of the UE on a symbol that overlaps with a symbol of a higher-priority transmission of another UE.

In some aspects, the cancellation indication is associated with one or more non-overlapped symbols of the uplink transmission.

In some aspects, the cancellation indication indicates that the UE is to use an increased transmit power, relative to the reduced transmit power, for one or more symbols of the uplink transmission.

In some aspects, the uplink transmission is a first uplink transmission that includes one or more overlapped symbols and one or more non-overlapped symbols relative to a second uplink transmission, the one or more overlapped symbols are associated with one or more first OLPC parameters, and the one or more non-overlapped symbols are associated with one or more second OLPC parameters.

In some aspects, the one or more first OLPC parameters comprise at least one of: an OLPC parameter associated with a symbol that is to use a higher transmit power than the reduced transmit power, an OLPC parameter associated with creating an LBT gap for another UE, or an OLPC parameter associated with avoiding a collision with the second uplink transmission.

In some aspects, a plurality of OLPC parameters, including the one or more first OLPC parameters, are applied for respective overlapped symbols including the one or more overlapped symbols.

In some aspects, when the uplink transmission is to be transmitted at the reduced transmit power, the cancellation indication is associated with a first processing timeline, and when the uplink transmission is to be cancelled, the cancellation indication is associated with a second processing timeline.

In some aspects, the method includes receiving capability information of the UE, wherein the first processing timeline is based at least in part on the capability information.

In some aspects, when the cancellation indication is associated with a collision between the uplink transmission and a higher-priority transmission of the UE, a processing timeline of the higher-priority transmission is increased relative to a baseline processing timeline.

In some aspects, the method includes receiving capability information of the UE, wherein the processing timeline is increased based at least in part on the capability information.

In some aspects, the cancellation indication is based at least in part on an overlap between the uplink transmission and a transmission by another UE.

In some aspects, the cancellation indication is based at least in part on an overlap between the uplink transmission and a higher-priority transmission that is associated with a higher priority level than the uplink transmission.

In some aspects, a UE for wireless communication may include a memory and one or more processors operatively coupled to the memory. The memory and the one or more processors may be configured to receive a cancellation indication associated with an uplink transmission on a shared radio frequency spectrum band, the shared radio frequency spectrum band having an LBT channel access mechanism to access the shared radio frequency spectrum band; determine, based at least in part on the reception of the cancellation indication associated with the uplink transmission on the shared radio frequency spectrum band, whether the uplink transmission is to be cancelled or transmitted at a reduced transmit power; and when the uplink transmission is to be transmitted at the reduced transmit power, transmit the uplink transmission at the reduced transmit power.

In some aspects, a base station for wireless communication may include a memory and one or more processors operatively coupled to the memory. The memory and the one or more processors may be configured to transmit, to a UE, a cancellation indication associated with an uplink transmission on a shared radio frequency spectrum band, the shared radio frequency spectrum band having an LBT channel access mechanism to access the shared radio frequency spectrum band; and when the uplink transmission is to be transmitted at the reduced transmit power, receive the uplink transmission based at least in part on the reduced transmit power.

In some aspects, a non-transitory computer-readable medium may store one or more instructions for wireless communication. The one or more instructions, when executed by one or more processors of a UE, may cause the one or more processors to receive a cancellation indication associated with an uplink transmission on a shared radio frequency spectrum band, the shared radio frequency spectrum band having an LBT channel access mechanism to access the shared radio frequency spectrum band; determine, based at least in part on the reception of the cancellation indication associated with the uplink transmission on the shared radio frequency spectrum band, whether the uplink transmission is to be cancelled or transmitted at a reduced transmit power; and when the uplink transmission is to be transmitted at the reduced transmit power, transmit the uplink transmission at the reduced transmit power.

In some aspects, a non-transitory computer-readable medium may store one or more instructions for wireless communication. The one or more instructions, when executed by one or more processors of a base station, may cause the one or more processors to transmit, to a UE, a cancellation indication associated with an uplink transmission on a shared radio frequency spectrum band, the shared radio frequency spectrum band having an LBT channel access mechanism to access the shared radio frequency spectrum band; and when the uplink transmission is to be transmitted at the reduced transmit power, receive the uplink transmission at the reduced transmit power.

In some aspects, an apparatus for wireless communication may include means for receiving a cancellation indication associated with an uplink transmission on a shared radio frequency spectrum band, the shared radio frequency spectrum band having an LBT channel access mechanism to access the shared radio frequency spectrum band; means for determining, based at least in part on the reception of the cancellation indication associated with the uplink transmission on the shared radio frequency spectrum band, whether the uplink transmission is to be cancelled or transmitted at a reduced transmit power; and when the uplink transmission is to be transmitted at the reduced transmit power, transmitting the uplink transmission at the reduced transmit power.

In some aspects, an apparatus for wireless communication may include means for transmitting, to a UE, a cancellation indication associated with an uplink transmission on a shared radio frequency spectrum band, the shared radio frequency spectrum band having an LBT channel access mechanism to access the shared radio frequency spectrum band; and when the uplink transmission is to be transmitted at the reduced transmit power, means for receiving the uplink transmission at the reduced transmit power.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with various aspects of the present disclosure.

FIG. 2 is a diagram illustrating an example of a base station in communication with a UE in a wireless communication network, in accordance with various aspects of the present disclosure.

FIG. 3 is a diagram illustrating an example of soft cancellation of an uplink transmission.

FIGS. 4-6 are diagrams illustrating examples of uplink communications associated with cancellation indications, in accordance with various aspects of the present disclosure.

FIG. 7 is a diagram illustrating an example process performed, for example, by a user equipment, in accordance with various aspects of the present disclosure.

FIG. 8 is a diagram illustrating an example process performed, for example, by a base station, in accordance with various aspects of the present disclosure.

FIG. 9 is a conceptual data flow diagram illustrating a data flow between different components in an example apparatus, in accordance with various aspects of the present disclosure.

FIG. 10 is a conceptual data flow diagram illustrating a data flow between different components in an example apparatus, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

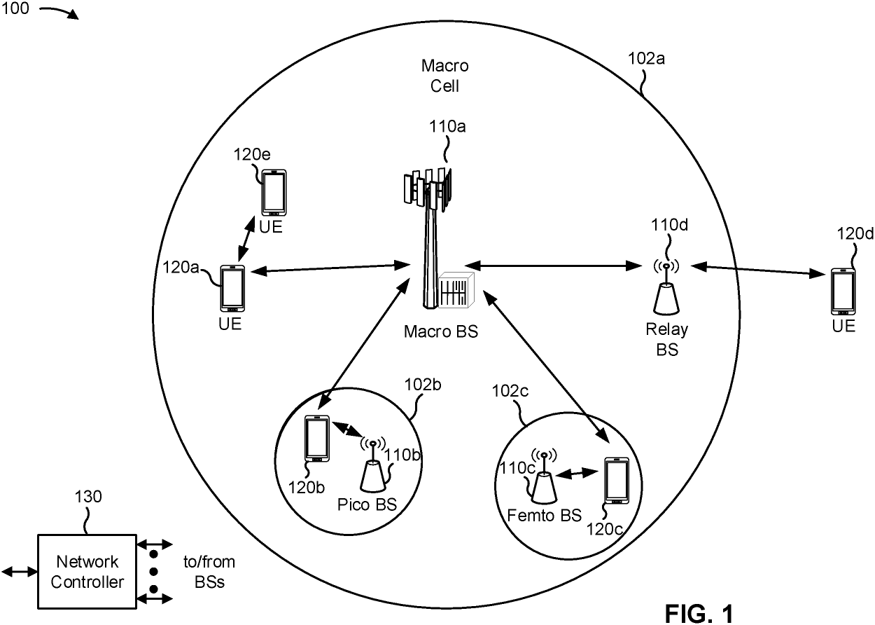

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

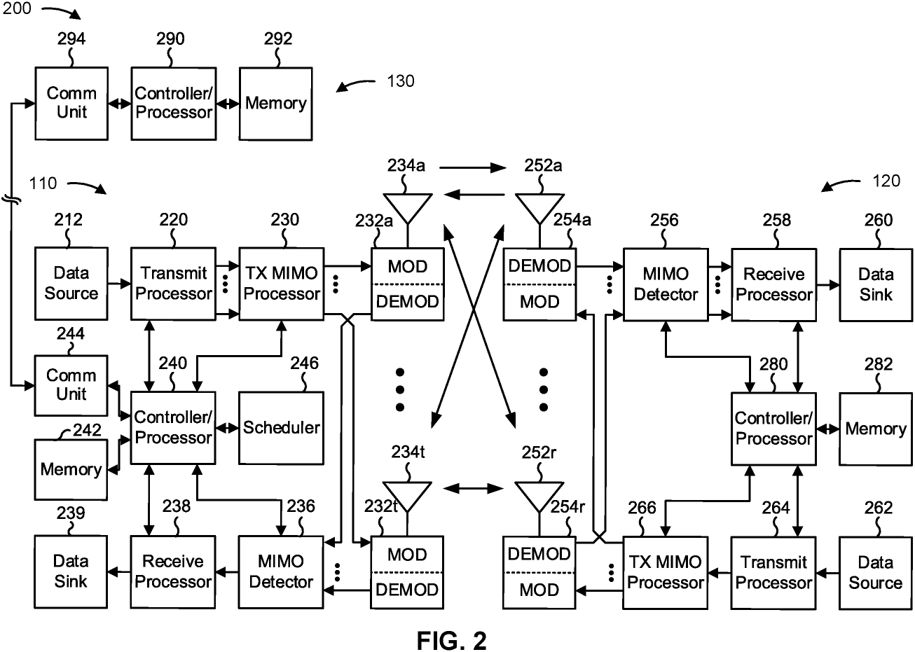

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

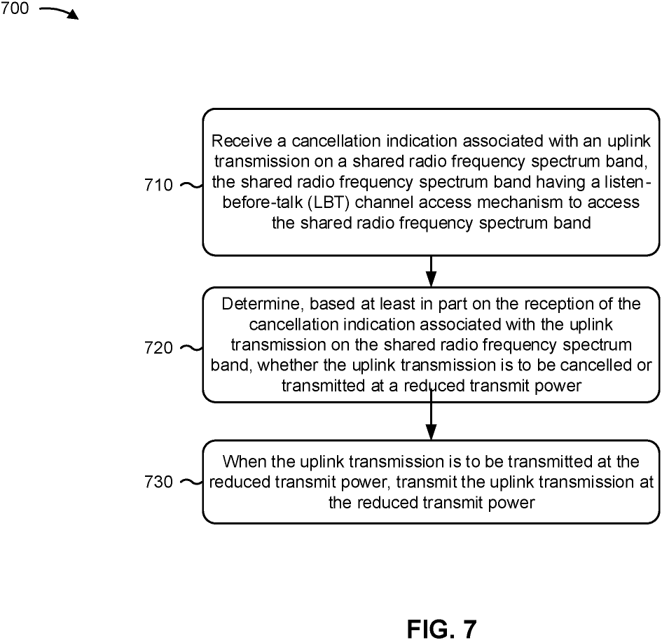

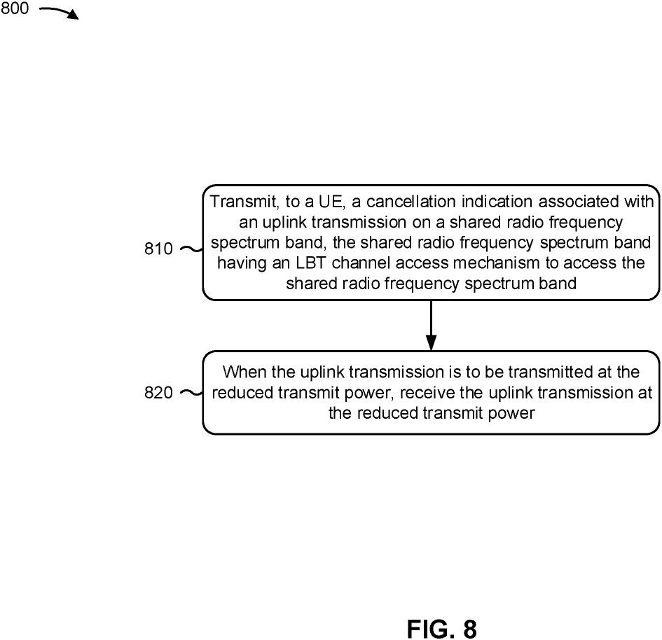

Controller/processor 240 of base station 110, controller/processor 280 of UE 120, and/or any other component(s) of FIG. 2 may perform one or more techniques associated with soft cancellation of an uplink transmission, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 700 of FIG. 7, process 800 of FIG. 8, and/or other processes as described herein. A scheduler 246 may schedule UEs for data transmission on the downlink and/or uplink.

In some aspects, UE 120 may include means for receiving a cancellation indication associated with an uplink transmission on a shared radio frequency spectrum band, the shared radio frequency spectrum band having a listen-before-talk (LBT) channel access mechanism to access the shared radio frequency spectrum band; means for determining, based at least in part on the reception of the cancellation indication associated with the uplink transmission on the shared radio frequency spectrum band, whether the uplink transmission is to be cancelled or transmitted at a reduced transmit power; means for transmitting the uplink transmission at the reduced transmit power; means for transmitting the second uplink transmission without performing an LBT operation between the first uplink transmission and the second uplink transmission; means for cancelling a final TTI, repetition, or reference signal of the uplink transmission; means for transmitting, at the reduced transmit power, one or more preceding TTIs, repetitions, or reference signals of the uplink transmission; means for transmitting capability information of the UE, wherein a processing timeline is based at least in part on the capability information; means for transmitting capability information of the UE, wherein a processing timeline is increased based at least in part on the capability information; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting, to a UE, a cancellation indication associated with an uplink transmission on a shared radio frequency spectrum band, the shared radio frequency spectrum band having an LBT channel access mechanism to access the shared radio frequency spectrum band; means for receiving the uplink transmission at the reduced transmit power; means for transmitting an indication of whether the uplink transmission is to be cancelled or transmitted at the reduced transmit power; means for determining that a final TTI, repetition, or reference signal of the uplink transmission is cancelled; means for determining that one or more preceding TTIs, repetitions, or reference signals of the uplink transmission are associated with the reduced transmit power; means for receiving capability information of the UE, wherein a processing timeline is based at least in part on the capability information; means for receiving capability information of the UE, wherein a processing timeline is increased based at least in part on the capability information; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

Network traffic may be associated with a priority level. The priority level may be used to manage network resources so that network traffic associated with a higher priority level is prioritized (e.g., with regard to latency, throughput, reliability, and/or the like) over network traffic associated with a lower priority level. In 5G/NR, ultra-reliable low latency communication (URLLC) traffic may be associated with a higher priority level than other forms of traffic, such as enhanced mobile broadband (eMBB) traffic. Thus, URLLC traffic may be associated with more stringent latency and/or reliability requirements than eMBB traffic.

A base station may transmit an uplink cancellation indication (sometimes referred to as a cancellation indication) to a UE. The uplink cancellation indication may indicate that the UE is to cancel transmission of an uplink transmission. One application of an uplink cancellation is to cancel a lower-priority transmission so that a UE (e.g., the same UE that transmits the lower-priority transmission or a different UE) can transmit a higher-priority transmission. For example, a UE that detects a downlink control information (DCI) format 2_4 for a serving cell may cancel a physical uplink shared channel (PUSCH) transmission, or a repetition of a PUSCH transmission if the PUSCH transmission is associated with repetitions, or a sounding reference signal (SRS) transmission on the serving cell if, respectively, a group of symbols, from T_{CI} symbols, has a corresponding bit value of ‘1’ in the DCI format 2_4 and includes a symbol of the (repetition of the) PUSCH transmission or of the SRS transmission, and a group of physical resource blocks (PRBs), from B_{CI} PRBs, has a corresponding bit value of ‘1’ in the DCI format 2_4 and includes a PRB of the (repetition of the) PUSCH transmission or of the SRS transmission, where the cancellation of the (repetition of the) PUSCH transmission includes all symbols from the earliest symbol of the (repetition of the) PUSCH transmission that are in one or more groups of symbols having corresponding bit values of ‘1’ in the DCI format 2_4, and the cancellation of the SRS transmission includes only symbols that are in one or more groups of symbols having corresponding bit values of ‘1’ in the DCI format 2_4.

In some aspects, when a higher-priority uplink transmission overlaps with a lower-priority uplink transmission in a slot, the UE is expected to cancel the lower-priority uplink transmission starting from T_{proc},₂ + d1 after the end of a physical downlink control channel (PDCCH) scheduling the higher-priority transmission, where T_{Proc},₂ corresponds to a UE processing time capability for the carrier, and d1 is a time duration corresponding to 0, 1, or 2 symbols as reported in association with UE capability information. In such a case, a minimum processing time of the higher-priority channel may be extended by d2 symbols, wherein d2 is a time duration corresponding to 0, 1, or 2 symbols as reported in association with UE capability information. The overlapping condition may be determined per repetition of the uplink transmission. Furthermore, when a higher-priority uplink transmission overlaps with a lower-priority uplink transmission in a slot, the UE may not expect to be scheduled to transmit in non-overlapped cancelled symbols.

Some frequency bands may be associated with shared radio frequency (RF) spectrum. For example, an unlicensed band in NR (e.g., an NR unlicensed (NR-U) band) may be associated with shared RF spectrum. In a shared RF spectrum band, there may be no central scheduler. Thus, devices communicating on a shared RF spectrum band may use channel access mechanisms, such as listen-before-talk (LBT) channel access mechanisms, to secure the channel medium before transmitting. Examples of LBT channel access mechanisms include Category 4 LBT (also referred to as Type 1 channel access), in which a random backoff and a variably sized contention window is used, and Category 2 LBT (also referred to as Type 2 channel access), in which a random backoff is not used.

In some aspects, a UE is scheduled with consecutive uplink transmissions. In such a case, if a UE is scheduled to transmit a plurality of uplink transmissions including a PUSCH using an uplink grant, and if the UE cannot access the channel for a transmission prior to a last transmission of the plurality of uplink transmissions, the UE may attempt to transmit the next transmission according to a channel access type indicated in the uplink grant. If a UE is scheduled to transmit a plurality of consecutive uplink transmissions without gaps including a PUSCH using one or more uplink grants, and the UE transmits one of the scheduled uplink transmissions in the plurality of consecutive uplink transmissions after accessing the channel according to Type 1 or Type 2 uplink channel access procedures, the UE may continue transmission of remaining uplink transmissions in the plurality of uplink transmissions, if any.

In some aspects, a UE may transmit contiguous uplink transmissions including a transmission pause. In such aspects, if a UE is scheduled to transmit a plurality of consecutive uplink transmissions without gaps using one or more uplink grants, and if the UE has stopped transmitting during or before one of the uplink transmissions in the plurality of uplink transmissions and prior to a last uplink transmission in the plurality of uplink transmissions, and if the channel is sensed by the UE to be continuously idle after the UE has stopped transmitting, the UE may transmit a later uplink transmission in the plurality of uplink transmissions using a Type 2 channel access procedure. If a channel sensed by a UE is not continuously idle after the UE has stopped transmitting, the UE may transmit a later uplink transmission in the plurality of uplink transmissions using a Type 1 channel access procedure with the uplink channel access priority class indicated in the DCI corresponding to the uplink transmission.

As described above, for some shared RF bands (e.g., NR-U bands), when a UE transmits with a pause, the UE may have to continuously sense the channel to be idle after the UE stops transmission in order to transmit later with Type 2 (i.e., Category 2) channel access, or the UE may use Type 1 (e.g., Category 4) channel access to re-secure the channel medium. When the UE transmits without a pause, the UE may not have to perform an LBT operation for subsequent consecutive transmissions based at least in part on gaining medium access for the earlier transmission. However, when a UE is indicated to cancel an uplink transmission associated with a contiguous resource allocation using a cancellation indication, the UE may experience a transmission pause in the contiguous resource allocation. As a result, the UE may perform medium sensing to resume transmission, which may increase the likelihood of an unsuccessful subsequent transmission, and may consume computing and communication resources of the UE. Unsuccessful subsequent transmissions may have a disproportionate impact on lower-priority communications, since lower-priority communications are likely to be cancelled to facilitate the transmission of higher-priority transmissions.

Some techniques and apparatuses described herein provide soft cancellation of an uplink transmission. As used herein, “soft cancellation” refers to reducing the transmit power of an uplink transmission to a value greater than zero based at least in part on receiving a cancellation indication associated with the uplink transmission. Some techniques and apparatuses described herein provide soft cancellation for uplink transmissions associated with a single UE (e.g., intra-UE prioritization) and uplink transmissions associated with multiple UEs (e.g., inter-UE prioritization). By performing soft cancellation, a UE may not surrender the channel medium in the case of cancellation of an uplink transmission. Thus, the UE may not perform an LBT operation to re-secure the channel medium. In this way, reliability of transmissions, particularly transmissions subsequent to a cancellation indication, is improved. Furthermore, computing and communication resources associated with re-securing the channel medium for such a subsequent transmission are conserved.

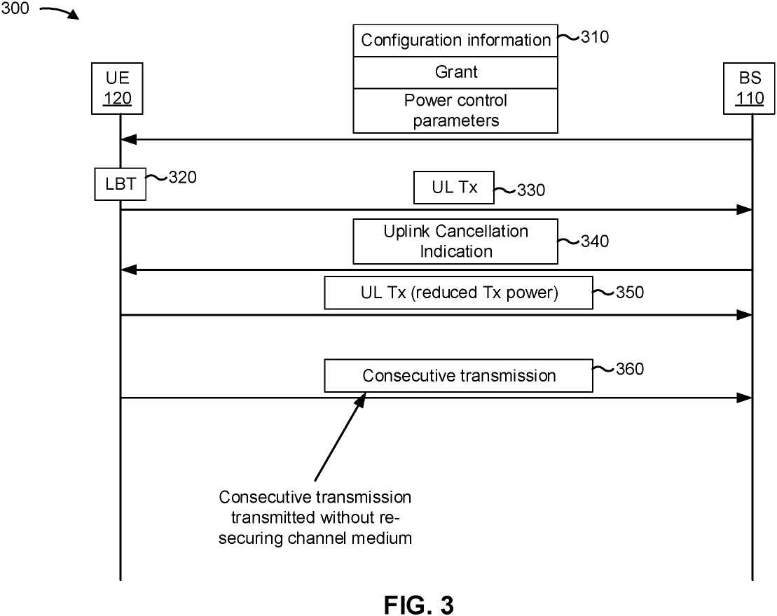

FIG. 3 is a diagram illustrating an example 300 of soft cancellation of an uplink transmission. As shown in FIG. 3, a UE 120 and a BS 110 may communicate with one another.

As show by reference number 310, the BS 110 may provide configuration information to the UE 120. In some aspects, the configuration information may include a grant for an uplink transmission, such as a PUSCH or an aperiodic reference signal (e.g., a sounding reference signal (SRS), a positioning reference signal (PRS), and/or the like). In some aspects, the configuration may relate to a repetitious communication, such as a periodic SRS or PRS, a semi-persistent SRS or PRS, a multi-transmission-time-interval (multi-TTI) transmission, a PUSCH with slot aggregation, and/or the like. In some aspects, the configuration may include grants for the uplink transmission and a subsequent transmission, or for multiple uplink transmissions of the UE 120.

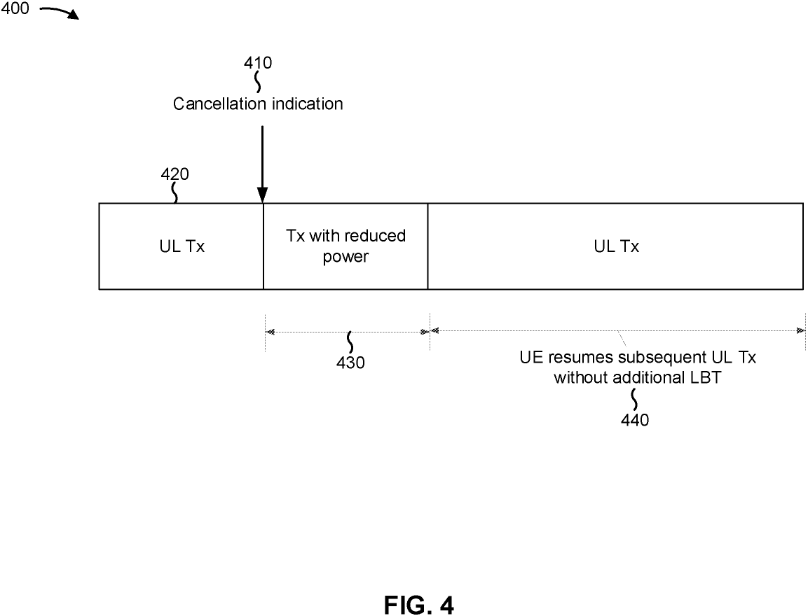

As further shown, in some aspects, the configuration information may include information indicating one or more power control parameters. The one or more power control parameters may indicate a transmit power to be used for the uplink transmission if a cancellation indication pertaining to the uplink transmission is received by the UE 120. For example, the one or more power control parameters may include open loop power control (OLPC) parameters and/or the like. FIGS. 4-6 describe the OLPC parameters in more detail.

In some aspects, the configuration information may include information associated with determining whether an uplink transmission is to be transmitted at a reduced power or is to be cancelled. An uplink transmission that is transmitted at a reduced power (e.g., a non-zero power) may be referred to as a soft-cancelled transmission, and an uplink transmission that is not transmitted or is associated with a zero-power transmit power may be referred to as a hard-cancelled transmission. In some aspects, the configuration information may indicate whether a transmission type or plurality of transmissions is to be hard-cancelled or soft-cancelled. For example, in a case of an uplink transmission with one or more overlapped symbols that overlap a higher-priority transmission, the configuration information may indicate whether overlapped symbols are to be hard-cancelled or soft cancelled.

In some aspects, for a PUSCH transmission, the BS 110 may provide an indication (e.g., in the grant or the configuration information) regarding how the UE 120 is to perform cancellation. For example, the grant or the configuration information may indicate whether the PUSCH transmission is to be hard-cancelled or soft-cancelled. In some aspects, for a multi-TTI grant or a PUSCH with slot aggregation, the configuration information or the grant may indicate that a last TTI or a last repetition is to be hard-cancelled while earlier one or more TTIs or earlier repetitions are to be soft-cancelled. In some aspects, for a periodic or semi-persistent SRS/PRS, the configuration information may indicate that the UE 120 is to perform soft-cancellation. In some aspects, for an aperiodic SRS/PRS, the BS 110 may provide an indication, in the grant triggering the aperiodic SRS/PRS, of how the UE 120 is to perform cancellation (e.g., hard-cancellation or soft-cancellation). This indication may apply to a last SRS/PRS symbol, while earlier SRS/PRS symbols may use soft cancellation.

In some aspects, the configuration information may indicate a processing timeline, or an adjustment to a processing timeline, for a UE 120. As described elsewhere herein, a cancellation indication may be associated with a processing timeline. In some aspects, the configuration information may indicate that the processing timeline is to be modified for soft cancellation. For example, the configuration information may indicate that the processing timeline is to be increased when soft cancellation is performed, relative to when hard cancellation is performed, thereby providing time for the UE 120 to adjust transmit power of the uplink transmission. In some aspects, for intra-UE prioritization (where a lower-priority transmission of the UE 120 is cancelled in order to facilitate a higher-priority transmission), a processing timeline associated with the higher-priority transmission may be increased. For example, the processing timeline may be increased for the UE 120 to adjust transmission power on the lower-priority transmission after the higher-priority transmission is performed. In some aspects, the processing timeline may be based at least in part on a UE capability indication. For example, the UE 120 may provide capability information regarding a processing timeline (e.g., one or more of the processing timelines described above) and the BS 110 may adjust the UE 120′s processing timeline in accordance with the UE 120′s capability information. Thus, UEs associated with different processing capabilities may be configured with different processing timelines, thereby improving efficiency of operation of such UEs.

As shown by reference number 320, the UE 120 may perform an LBT operation. For example, the UE 120 may perform a Type 1 or Type 2 LBT operation to secure channel access on the shared RF spectrum associated with the UE 120 so that the UE 120 can perform the uplink transmission.

As shown by reference number 330, the UE 120 may perform an uplink transmission. For example, the UE 120 may initiate the uplink transmission associated with the grant shown by reference number 310. As shown by reference number 340, the UE 120 may receive an uplink cancellation indication associated with the uplink transmission. For example, the UE 120 may receive the uplink cancellation indication during the transmission of the uplink transmission based at least in part on intra-UE or inter-UE prioritization of a higher-priority transmission. The uplink cancellation indication may include information identifying symbols or resource blocks (RBs) for which soft cancellation or hard cancellation is to be performed. For example, the information may include a bitmap and/or the like.

In some aspects, the BS 110 may transmit the uplink cancellation indication in order to cause low-power transmission at the UE 120, so that a higher-priority UE 120 has a better chance of succeeding in an LBT operation. In this case, the UE 120′s transmission may impact medium access of the higher-priority UE 120. Thus, the reduction in the transmit power of the uplink transmission may be more stringent in such a case than in other cases described herein.

In some aspects, the BS 110 may transmit the uplink cancellation indication based at least in part on one or more cancelled symbols of the uplink transmission overlapping with a transmission of a higher-priority UE. For example, the UE 120′s uplink transmission on the overlapped symbols may affect reception by other UEs, so the BS 110 may transmit the uplink cancellation indication to cause soft cancellation of the uplink transmission on the overlapped symbols.

In some aspects, the BS 110 may transmit the uplink cancellation indication for one or more non-overlapped symbols. For example, the UE 120′s transmission may be useful for detection of the UE 120, so it may not be beneficial to perform hard cancellation of a transmission. As another example, the BS 110 may determine that the lower-priority UE 120 is to use a higher transmit power in order to block potential interferers so that a higher-priority UE has a better probability of passing an LBT operation. Thus, the BS 110 may provide a cancellation indication that identifies a plurality of non-overlapped symbols, and may signal that the UE 120 is to use OLPC parameters associated with a higher transmit power on the set of non-overlapped symbols.

As shown by reference number 350, the UE 120 may perform the uplink transmission at a reduced transmit power. For example, the UE 120 may perform the uplink transmission using one or more OLPC parameters identified by the configuration information, thereby transmitting the uplink transmission using soft cancellation. In some aspects, the UE 120 may perform soft cancellation of an uplink transmission in a given transport block (TB) or a given repetition of the uplink transmission based at least in part on one or more symbols of the uplink transmission being cancelled in the given TB or the given repetition.

As shown by reference number 360, the UE 120 may perform a consecutive transmission after the uplink transmission. For example, the consecutive transmission may be scheduled contiguously with and subsequent to the uplink transmission. As further shown, the UE 120 may perform the consecutive transmission without performing an LBT operation between the consecutive transmission and the uplink transmission. For example, if the UE 120 uses soft cancellation for the uplink transmission, then the UE 120 may not surrender the channel medium, and thus may not perform another LBT operation. In this way, likelihood of success of the consecutive transmission is improved and resources associated with performing the LBT operation are conserved.

If a subsequent transmission is not scheduled after the uplink transmission, then the UE 120 may hard-cancel the uplink transmission based at least in part on the cancellation indication, since the UE 120 would surrender the channel medium due to a gap between the uplink transmission and the subsequent transmission whether or not the UE 120 performs the uplink transmission at a reduced transmit power.

As indicated above, FIG. 3 is provided as an example. Other examples may differ from what is described with respect to FIG. 3.

FIGS. 4-6 are diagrams illustrating examples 400, 500, and 600 of uplink communications associated with cancellation indications, in accordance with various aspects of the present disclosure.

FIG. 4 shows an example of soft cancellation to support inter-UE prioritization. In FIG. 4, a UE 120 receives a cancellation indication 410 partway through an uplink transmission (UL Tx) 420. The cancellation indication 410 may be based at least in part on the uplink transmission 420 being associated with a lower priority level than a transmission by another UE (not shown in FIG. 4). For example, a BS may determine that the transmission by the other UE is associated with a higher priority level, and may provide the cancellation indication 410 to perform soft cancellation of the uplink transmission 420 in a window 430 corresponding to the transmission by the other UE. As shown by reference number 440, the UE 120 may perform a subsequent uplink transmission without performing an LBT operation. Thus, the UE 120 avoids performing an LBT operation for the subsequent uplink transmission, thereby conserving resources of the UE 120, and reducing interference with the higher-priority transmission.

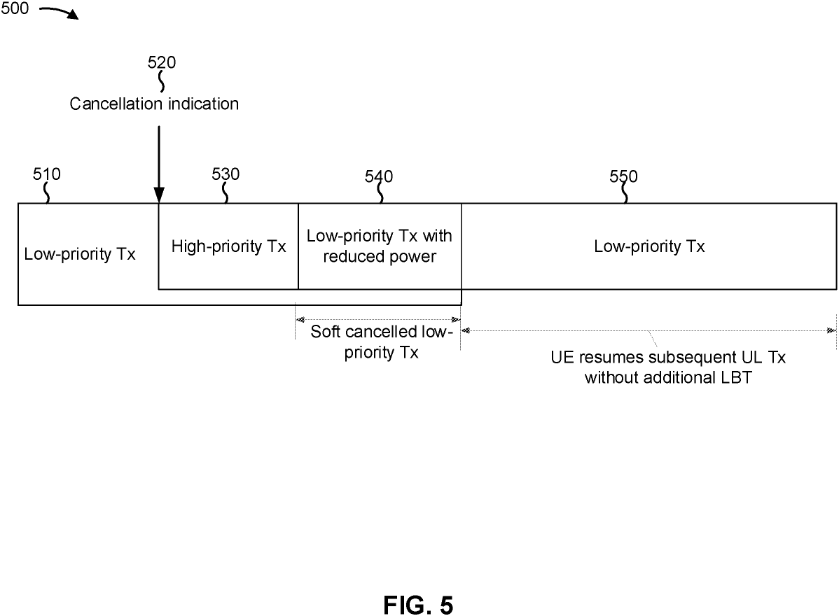

FIG. 5 shows an example of soft cancellation to support intra-UE prioritization. As shown in FIG. 5, a UE 120 may perform a low-priority transmission (Tx) 510. A lower edge of the block representing the low-priority transmission 510 shows a length of the low-priority transmission 510 if the low-priority transmission 510 is not interrupted.

As shown, the UE 120 may receive a cancellation indication 520. For example, the UE 120 may receive the cancellation indication 520 in association with a high-priority transmission 530 to be performed by the UE 120. As further shown, the UE 120 may perform the high-priority transmission 530. For example, the UE 120 may hard-cancel the low-priority transmission 510 during the high-priority transmission 530. Here, no LBT operation is performed for the high-priority transmission 530 since the UE 120 had already secured the channel medium for the low-priority transmission 510.

As shown by reference number 540, the UE 120 may transmit the low-priority transmission with a reduced transmit power. For example, the UE 120 may perform soft cancellation for the low-priority transmission before a next transmission 550. Thus, the UE 120 may prevent surrendering the channel medium after performing the high-priority transmission 530. For example, if the UE 120 were to hard-cancel the low-priority transmission 540, then the UE 120 may have to perform an LBT operation to secure the channel medium for the low-priority transmission 550. By performing soft cancellation of the low-priority transmission 540, the UE 120 conserves resources that would otherwise be used to perform an LBT operation for the transmission 550 and increases a likelihood of successful transmission of the transmission 550.

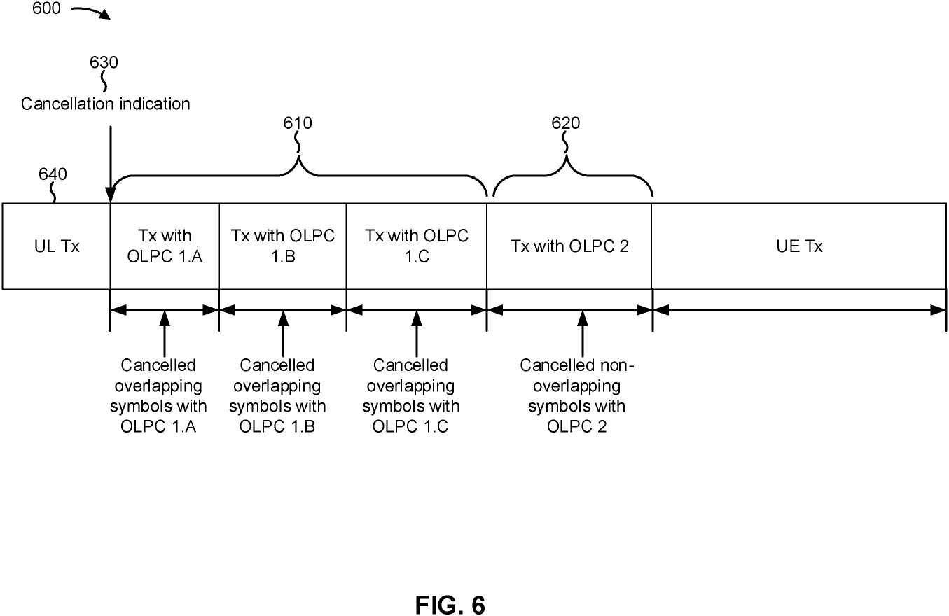

FIG. 6 is a diagram illustrating an example 600 of application of different power control parameters for different sets of symbols. In example 600, transmissions of a UE 120 overlap with transmissions of another UE (not shown in FIG. 6). Example 600 includes overlapped symbols 610 and non-overlapped symbols 620. The overlapped symbols 610 overlap the transmissions of the other UE, and the non-overlapped symbols 610 do not overlap the transmissions of the other UE.

As shown, the UE 120 may receive a cancellation indication 630. Accordingly, the UE 120 may perform soft cancellation of an uplink transmission 640, such as with regard to the overlapped symbols 610 and the non-overlapped symbols 620. In example 600, the UE 120 uses different OLPC parameters for the overlapped symbols 610 than for the non-overlapped symbols 620. As shown, the UE 120 uses OLPC parameters 1.A, 1.B, and 1.C for the overlapped symbols 610, and OLPC parameter 2 for the non-overlapped symbols 620. In some aspects, the cancellation indication 630 may indicate whether a symbol is to use a first OLPC parameter (e.g., OLPC parameter 1, which may include OLPC parameters 1.A, 1.B, and 1.C) or a second OLPC parameter (e.g., OLPC parameter 2). In some aspects, the UE 120 determine whether to use the first OLPC parameter or the second OLPC parameter, for example, based at least in part on whether a symbol is overlapped or non-overlapped. This may be applicable for intra-UE prioritization (when the symbol overlaps with another transmission of the UE 120) and for inter-UE prioritization (when the symbol overlaps with a transmission of another UE 120).

In some aspects, the OLPC parameters 1.A, 1.B, and 1.C may be different from each other. The UE 120 may apply an OLPC parameter based at least in part on a rule or condition associated with a corresponding symbol, or based at least in part on signaling indicating which OLPC parameter is to be applied. For example, the UE 120 may apply OLPC parameter 1.A for one or more overlapped symbols on which the UE 120 is to transmit with a higher transmit power in order to clean up potential interferers so that a higher-priority UE can secure the channel medium. As another example, the UE 120 may apply OLPC parameter 1.B for one or more symbols associated with creating an LBT gap for a higher-priority UE. As yet another example, the UE 120 may apply OLPC parameter 1.C for one or more symbols in which the UE 120 is to avoid collision of the uplink transmission with higher-priority traffic. The UE 120 may receive signaling indicating when to apply OLPC parameters. For example, a BS may configure the UE to apply a first OLPC parameter for a first N1 overlapped symbols, a second OLPC parameter for a second N2 overlapped symbols, and a third OLPC parameter for a remainder of the overlapped symbols, where N1 and N2 are integers. Thus, soft cancellation on overlapped signals with reduced transmit power can reduce interference on higher-priority traffic, and can enable the UE to hold the channel in order to resume subsequent uplink transmissions.

FIG. 7 is a diagram illustrating an example process 700 performed, for example, by a UE, in accordance with various aspects of the present disclosure. Example process 700 is an example where the UE (e.g., UE 120 and/or the like) performs operations associated with techniques for soft cancelling an uplink transmission.

As shown in FIG. 7, in some aspects, process 700 may include receiving a cancellation indication associated with an uplink transmission on a shared radio frequency spectrum band, the shared radio frequency spectrum band having a listen-before-talk (LBT) channel access mechanism to access the shared radio frequency spectrum band (block 710). For example, the UE (e.g., using antenna 252, DEMOD 254, MIMO detector 256, receive processor 258, controller/processor 280, and/or the like) may receive a cancellation indication associated with an uplink transmission on a shared radio frequency spectrum band, the shared radio frequency spectrum band having an LBT channel access mechanism to access the shared radio frequency spectrum band, as described above.

As further shown in FIG. 7, in some aspects, process 700 may include determining, based at least in part on the reception of the cancellation indication associated with the uplink transmission on the shared radio frequency spectrum band, whether the uplink transmission is to be cancelled or transmitted at a reduced transmit power (block 720). For example, the UE (e.g., using antenna 252, DEMOD 254, MIMO detector 256, receive processor 258, controller/processor 280, and/or the like) may determine, based at least in part on the reception of the cancellation indication associated with the uplink transmission on the shared radio frequency spectrum band, whether the uplink transmission is to be cancelled or transmitted at a reduced transmit power, as described above.

As further shown in FIG. 7, in some aspects, process 700 may include, when the uplink transmission is to be transmitted at the reduced transmit power, transmitting the uplink transmission at the reduced transmit power (block 730). For example, the UE (e.g., using controller/processor 280, transmit processor 264, TX MIMO processor 266, MOD 254, antenna 252, and/or the like) may, when the uplink transmission is to be transmitted at the reduced transmit power, transmit the uplink transmission at the reduced transmit power, as described above. When the uplink transmission is to be cancelled, the UE may not transmit the uplink transmission (e.g., may perform hard cancellation of the uplink transmission).

Process 700 may include additional aspects, such as any single aspect or any combination of aspects described below and/or in connection with one or more other processes described elsewhere herein.

In a first aspect, the uplink transmission is a first uplink transmission, and the first uplink transmission is transmitted at the reduced transmit power based at least in part on the UE being configured to transmit a second uplink transmission subsequent to the first uplink transmission.

In a second aspect, alone or in combination with the first aspect, process 700 includes transmitting the second uplink transmission without performing an LBT operation between the first uplink transmission and the second uplink transmission.

In a third aspect, alone or in combination with one or more of the first and second aspects, the determination is based at least in part on whether the uplink transmission overlaps another uplink transmission.

In a fourth aspect, alone or in combination with one or more of the first through third aspects, the uplink transmission is a first uplink transmission, and the first uplink transmission is cancelled based at least in part on a second uplink transmission of the UE being non-consecutive with the first uplink transmission.

In a fifth aspect, alone or in combination with one or more of the first through fourth aspects, the determination is based at least in part on receiving an indication of whether the uplink transmission is to be cancelled or transmitted at the reduced transmit power.

In a sixth aspect, alone or in combination with one or more of the first through fifth aspects, the indication is received in a grant associated with the uplink transmission.

In a seventh aspect, alone or in combination with one or more of the first through sixth aspects, when the uplink transmission is associated with a multi-transmission-time-interval (multi-TTI) grant, an uplink shared channel with slot aggregation, or an aperiodic reference signal, the method further comprises: cancelling a final TTI, repetition, or reference signal of the uplink transmission, and transmitting, at the reduced transmit power, one or more preceding TTIs, repetitions, or reference signals of the uplink transmission.

In an eighth aspect, alone or in combination with one or more of the first through seventh aspects, the reduced transmit power is selected based at least in part on the uplink transmission being associated with a periodic or semi-persistent reference signal.

In a ninth aspect, alone or in combination with one or more of the first through eighth aspects, the reduced transmit power is associated with an open-loop power control parameter that is applied for one or more symbols of the uplink transmission that are to be transmitted at the reduced transmit power.

In a tenth aspect, alone or in combination with one or more of the first through ninth aspects, the uplink transmission is a first uplink transmission that includes one or more overlapped symbols and one or more non-overlapped symbols relative to a second uplink transmission, the one or more overlapped symbols are associated with one or more first open-loop power control (OLPC) parameters, and the one or more non-overlapped symbols are associated with one or more second OLPC parameters.

In an eleventh aspect, alone or in combination with one or more of the first through tenth aspects, the one or more first OLPC parameters comprise at least one of: an OLPC parameter associated with a symbol that is to use a higher transmit power than the reduced transmit power, an OLPC parameter associated with creating an LBT gap for another UE, or an OLPC parameter associated with avoiding a collision with the second uplink transmission.

In a twelfth aspect, alone or in combination with one or more of the first through eleventh aspects, a plurality of OLPC parameters, including the one or more first OLPC parameters, are applied for respective overlapped symbols including the one or more overlapped symbols.

In a thirteenth aspect, alone or in combination with one or more of the first through twelfth aspects, when the uplink transmission is to be transmitted at the reduced transmit power, the cancellation indication is associated with a first processing timeline, and when the uplink transmission is to be cancelled, the cancellation indication is associated with a second processing timeline.

In a fourteenth aspect, alone or in combination with one or more of the first through thirteenth aspects, process 700 includes transmitting capability information of the UE, wherein the first processing timeline is based at least in part on the capability information.

In a fifteenth aspect, alone or in combination with one or more of the first through fourteenth aspects, when the cancellation indication is associated with a collision between the uplink transmission and a higher-priority transmission of the UE, a processing timeline of the higher-priority transmission is increased relative to a baseline processing timeline.

In a sixteenth aspect, alone or in combination with one or more of the first through fifteenth aspects, process 700 includes transmitting capability information of the UE, wherein the processing timeline is increased based at least in part on the capability information.

In a seventeenth aspect, alone or in combination with one or more of the first through sixteenth aspects, the cancellation indication is based at least in part on an overlap between the uplink transmission and a transmission by another UE.

In an eighteenth aspect, alone or in combination with one or more of the first through seventeenth aspects, the cancellation indication is based at least in part on an overlap between the uplink transmission and a higher-priority transmission by the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., BS 110 and/or the like) performs operations associated with techniques for soft cancelling an uplink transmission.

As shown in FIG. 8, in some aspects, process 800 may include transmitting, to a UE, a cancellation indication associated with an uplink transmission on a shared radio frequency spectrum band, the shared radio frequency spectrum band having an LBT channel access mechanism to access the shared radio frequency spectrum band (block 810). For example, the base station (e.g., using controller/processor 240, transmit processor 220, TX MIMO processor 230, MOD 232, antenna 234, and/or the like) may transmit, to a UE, a cancellation indication associated with an uplink transmission on a shared radio frequency spectrum band, the shared radio frequency spectrum band having an LBT channel access mechanism to access the shared radio frequency spectrum band, as described above. In some aspects, the uplink transmission is to be cancelled or transmitted at a reduced transmit power based at least in part on the cancellation indication and based at least in part on the uplink transmission being on the band associated with the LBT channel access mechanism.

As further shown in FIG. 8, in some aspects, process 800 may include, when the uplink transmission is to be transmitted at the reduced transmit power, receiving the uplink transmission based at least in part on the reduced transmit power (block 820). For example, the base station (e.g., using antenna 234, DEMOD 232, MIMO detector 236, receive processor 238, controller/processor 240, and/or the like) may, when the uplink transmission is transmitted at the reduced transmit power, receive the uplink transmission based at least in part on the reduced transmit power, as described above.

Process 800 may include additional aspects, such as any single aspect or any combination of aspects described below and/or in connection with one or more other processes described elsewhere herein.

In a first aspect, the uplink transmission is a first uplink transmission, and the first uplink transmission is associated with the reduced transmit power based at least in part on the UE being configured to transmit a second uplink transmission subsequent to the first uplink transmission.

In a second aspect, alone or in combination with the first aspect, process 800 includes determining whether the uplink transmission is to be cancelled or transmitted at the reduced transmit power based at least in part on whether the uplink transmission overlaps with another uplink transmission.

In a third aspect, alone or in combination with one or more of the first and second aspects, the uplink transmission is a first uplink transmission, and the first uplink transmission is cancelled based at least in part on a second uplink transmission of the UE being non-consecutive with the first uplink transmission.

In a fourth aspect, alone or in combination with one or more of the first through third aspects, process 800 includes transmitting an indication of whether the uplink transmission is to be cancelled or transmitted at the reduced transmit power.

In a fifth aspect, alone or in combination with one or more of the first through fourth aspects, the indication is provided in a grant associated with the uplink transmission.

In a sixth aspect, alone or in combination with one or more of the first through fifth aspects, when the uplink transmission is associated with a multi-TTI grant, an uplink shared channel with slot aggregation, or an aperiodic reference signal, the method further comprises: determining that a final TTI, repetition, or reference signal of the uplink transmission is cancelled, and determining that one or more preceding TTIs, repetitions, or reference signals of the uplink transmission are associated with the reduced transmit power.

In a seventh aspect, alone or in combination with one or more of the first through sixth aspects, the reduced transmit power is selected based at least in part on the uplink transmission being associated with a periodic or semi-persistent reference signal.

In an eighth aspect, alone or in combination with one or more of the first through seventh aspects, the reduced transmit power is associated with an open-loop power control parameter that is associated with one or more symbols of the uplink transmission that are associated with the reduced transmit power.

In a ninth aspect, alone or in combination with one or more of the first through eighth aspects, the transmission of the cancellation indication is associated with reducing a transmit power of the UE so that a higher-priority UE can secure channel access.

In a tenth aspect, alone or in combination with one or more of the first through ninth aspects, the transmission of the cancellation indication is associated with reducing a transmit power of the UE on a symbol that overlaps with a symbol of a higher-priority transmission of another UE.

In an eleventh aspect, alone or in combination with one or more of the first through tenth aspects, the cancellation indication is associated with one or more non-overlapped symbols of the uplink transmission.

In a twelfth aspect, alone or in combination with one or more of the first through eleventh aspects, the cancellation indication indicates that the UE is to use an increased transmit power, relative to the reduced transmit power, for one or more symbols of the uplink transmission.

In a thirteenth aspect, alone or in combination with one or more of the first through twelfth aspects, the uplink transmission is a first uplink transmission that includes one or more overlapped symbols and one or more non-overlapped symbols relative to a second uplink transmission, the one or more overlapped symbols are associated with one or more first OLPC parameters, and the one or more non-overlapped symbols are associated with one or more second OLPC parameters.

In a fourteenth aspect, alone or in combination with one or more of the first through thirteenth aspects, the one or more first OLPC parameters comprise at least one of: an OLPC parameter associated with a symbol that is to use a higher transmit power than the reduced transmit power, an OLPC parameter associated with creating an LBT gap for another UE, or an OLPC parameter associated with avoiding a collision with the second uplink transmission.

In a fifteenth aspect, alone or in combination with one or more of the first through fourteenth aspects, a plurality of OLPC parameters, including the one or more first OLPC parameters, are applied for respective overlapped symbols including the one or more overlapped symbols.

In a sixteenth aspect, alone or in combination with one or more of the first through fifteenth aspects, when the uplink transmission is to be transmitted at the reduced transmit power, the cancellation indication is associated with a first processing timeline, and when the uplink transmission is to be cancelled, the cancellation indication is associated with a second processing timeline.

In a seventeenth aspect, alone or in combination with one or more of the first through sixteenth aspects, process 800 includes receiving capability information of the UE, wherein the first processing timeline is based at least in part on the capability information.

In an eighteenth aspect, alone or in combination with one or more of the first through seventeenth aspects, when the cancellation indication is associated with a collision between the uplink transmission and a higher-priority transmission of the UE, a processing timeline of the higher-priority transmission is increased relative to a baseline processing timeline.

In a nineteenth aspect, alone or in combination with one or more of the first through eighteenth aspects, process 800 includes receiving capability information of the UE, wherein the processing timeline is increased based at least in part on the capability information.

In a twentieth aspect, alone or in combination with one or more of the first through nineteenth aspects, the cancellation indication is based at least in part on an overlap between the uplink transmission and a transmission by another UE.

In a twenty-first aspect, alone or in combination with one or more of the first through twentieth aspects, the cancellation indication is based at least in part on an overlap between the uplink transmission and a higher-priority transmission that is associated with a higher priority level than the uplink transmission.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

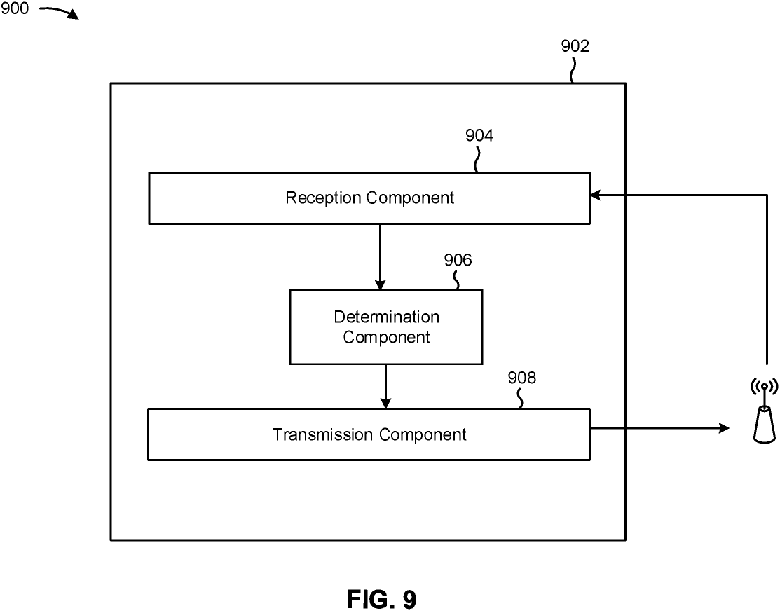

FIG. 9 is a conceptual data flow diagram 900 illustrating a data flow between different components in an example apparatus 902. The apparatus 902 may be a UE (e.g., UE 120). In some aspects, the apparatus 902 includes a reception component 904, a determination component 906, and/or a transmission component 908.

The reception component 904 may receive a cancellation indication associated with an uplink transmission on a shared radio frequency spectrum band, the shared radio frequency spectrum band having a listen-before-talk (LBT) channel access mechanism to access the shared radio frequency spectrum band. The determination component 906 may determine, based at least in part on the reception of the cancellation indication associated with the uplink transmission on the shared radio frequency spectrum band, whether the uplink transmission is to be cancelled or transmitted at a reduced transmit power. The transmission component 908 may, when the uplink transmission is to be transmitted at the reduced transmit power, transmit the uplink transmission at the reduced transmit power.

The apparatus may include additional components that perform each of the blocks of the algorithm in the aforementioned process 700 of FIG. 7 and/or the like. Each block in the aforementioned process 700 of FIG. 7 and/or the like may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of components (e.g., one or more components) shown in FIG. 9 may perform one or more functions described as being performed by another set of components shown in FIG. 9.

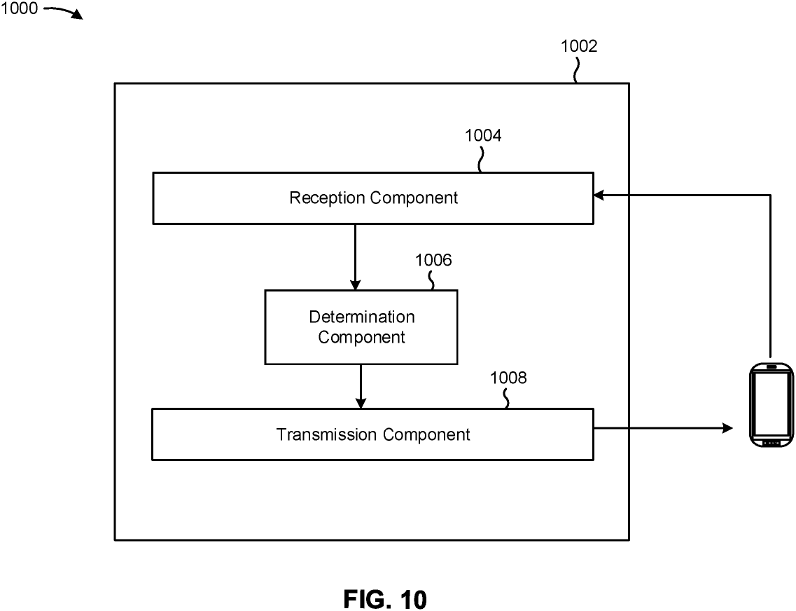

FIG. 10 is a conceptual data flow diagram 1000 illustrating a data flow between different components in an example apparatus 1002. The apparatus 1002 may be a base station (e.g., base station 110). In some aspects, the apparatus 1002 includes a reception component 1004, a determination component 1006, and/or a transmission component 1008.

The transmission component 1008 may transmit, to a UE, a cancellation indication associated with an uplink transmission on a shared radio frequency spectrum band, the shared radio frequency spectrum band having an LBT channel access mechanism to access the shared radio frequency spectrum band. The determination component 1006 may determining whether the uplink transmission is to be cancelled or transmitted at the reduced transmit power. The reception component 1004 may, when the uplink transmission is to be transmitted at the reduced transmit power, receiving the uplink transmission at the reduced transmit power.

The apparatus may include additional components that perform each of the blocks of the algorithm in the aforementioned process 700 of FIG. 7, process 800 of FIG. 8, and/or the like. Each block in the aforementioned process 700 of FIG. 7, process 800 of FIG. 8, and/or the like may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of components (e.g., one or more components) shown in FIG. 10 may perform one or more functions described as being performed by another set of components shown in FIG. 10.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving a cancellation indication associated with an uplink transmission on a shared radio frequency spectrum band, the shared radio frequency spectrum band having a listen-before-talk (LBT) channel access mechanism to access the shared radio frequency spectrum band;
determining, based at least in part on the reception of the cancellation indication associated with the uplink transmission on the shared radio frequency spectrum band, whether the uplink transmission is to be cancelled or transmitted at a reduced transmit power; and
when the uplink transmission is to be transmitted at the reduced transmit power, transmitting the uplink transmission at the reduced transmit power.

2. The method of claim 1, wherein the uplink transmission is a first uplink transmission, and wherein the first uplink transmission is transmitted at the reduced transmit power based at least in part on the UE being configured to transmit a second uplink transmission subsequent to the first uplink transmission.

3. The method of claim 2, further comprising:
transmitting the second uplink transmission without performing an LBT operation between the first uplink transmission and the second uplink transmission.

4. The method of claim 1, wherein the determination is based at least in part on whether the uplink transmission overlaps another uplink transmission.

5. The method of claim 1, wherein the uplink transmission is a first uplink transmission, and wherein the first uplink transmission is cancelled based at least in part on a second uplink transmission of the UE being non-consecutive with the first uplink transmission.

6. The method of claim 1, wherein the determination is based at least in part on receiving an indication of whether the uplink transmission is to be cancelled or transmitted at the reduced transmit power.

7. The method of claim 6, wherein the indication is received in a grant associated with the uplink transmission.

8. The method of claim 1, wherein, when the uplink transmission is associated with a multi-transmission-time-interval (multi-TTI) grant, an uplink shared channel with slot aggregation, or an aperiodic reference signal, the method further comprises:
cancelling a final TTI, repetition, or reference signal of the uplink transmission, and
transmitting, at the reduced transmit power, one or more preceding TTIs, repetitions, or reference signals of the uplink transmission.

9. The method of claim 1, wherein the reduced transmit power is selected based at least in part on the uplink transmission being associated with a periodic or semi-persistent reference signal.

10. The method of claim 1, wherein the reduced transmit power is associated with an open-loop power control parameter that is applied for one or more symbols of the uplink transmission that are to be transmitted at the reduced transmit power.

11. The method of claim 1, wherein the uplink transmission is a first uplink transmission that includes one or more overlapped symbols and one or more non-overlapped symbols relative to a second uplink transmission, and wherein the one or more overlapped symbols are associated with one or more first open-loop power control (OLPC) parameters and the one or more non-overlapped symbols are associated with one or more second OLPC parameters.

12. The method of claim 11, wherein the one or more first OLPC parameters comprise at least one of:
an OLPC parameter associated with a symbol that is to use a higher transmit power than the reduced transmit power,
an OLPC parameter associated with creating an LBT gap for another UE, or
an OLPC parameter associated with avoiding a collision with the second uplink transmission.

13. The method of claim 11, wherein a plurality of OLPC parameters, including the one or more first OLPC parameters, are applied for respective overlapped symbols including the one or more overlapped symbols.

14. The method of claim 1, wherein, when the uplink transmission is to be transmitted at the reduced transmit power, the cancellation indication is associated with a first processing timeline, and when the uplink transmission is to be cancelled, the cancellation indication is associated with a second processing timeline.

15. (canceled)

16. The method of claim 1, wherein, when the cancellation indication is associated with a collision between the uplink transmission and a higher-priority transmission of the UE, a processing timeline of the higher-priority transmission is increased relative to a baseline processing timeline.

17. (canceled)

18. The method of claim 1, wherein the cancellation indication is based at least in part on an overlap between the uplink transmission and a transmission by another UE or a higher-priority transmission by the UE.

19. (canceled)

20. A method of wireless communication performed by a base station, comprising:
transmitting, to a user equipment (UE), a cancellation indication associated with an uplink transmission on a shared radio frequency spectrum band, the shared radio frequency spectrum band having a listen-before-talk (LBT) channel access mechanism to access the shared radio frequency spectrum band; and
when the uplink transmission is to be transmitted at the reduced transmit power, receiving the uplink transmission at the reduced transmit power.

21. The method of claim 20, wherein the uplink transmission is a first uplink transmission, and wherein the first uplink transmission is associated with the reduced transmit power based at least in part on the UE being configured to transmit a second uplink transmission subsequent to the first uplink transmission.

22. The method of claim 20, further comprising determining whether the uplink transmission is to be cancelled or transmitted at the reduced transmit power based at least in part on whether the uplink transmission overlaps with another uplink transmission.

23. The method of claim 20, wherein the uplink transmission is a first uplink transmission, and wherein the first uplink transmission is cancelled based at least in part on a second uplink transmission of the UE being non-consecutive with the first uplink transmission.

24. The method of claim 20, further comprising:
transmitting an indication of whether the uplink transmission is to be cancelled or transmitted at the reduced transmit power.

25-27. (canceled)

28. The method of claim 20, wherein the reduced transmit power is associated with an open-loop power control parameter that is associated with one or more symbols of the uplink transmission that are associated with the reduced transmit power.

29. (canceled)

30. The method of claim 20, wherein the transmission of the cancellation indication is associated with reducing a transmit power of the UE on a symbol that overlaps with a symbol of a higher-priority transmission of another UE.

31. The method of claim 20, wherein the cancellation indication is associated with one or more non-overlapped symbols of the uplink transmission.

32. (canceled)

33. The method of claim 20, wherein the uplink transmission is a first uplink transmission that includes one or more overlapped symbols and one or more non-overlapped symbols relative to a second uplink transmission, and wherein the one or more overlapped symbols are associated with one or more first open-loop power control (OLPC) parameters and the one or more non-overlapped symbols are associated with one or more second OLPC parameters.

34-35. (canceled)

36. The method of claim 20, wherein, when the uplink transmission is to be transmitted at the reduced transmit power, the cancellation indication is associated with a first processing timeline, and when the uplink transmission is to be cancelled, the cancellation indication is associated with a second processing timeline.

37. (canceled)

38. The method of claim 20, wherein, when the cancellation indication is associated with a collision between the uplink transmission and a higher-priority transmission of the UE, a processing timeline of the higher-priority transmission is increased relative to a baseline processing timeline.

39-41. (canceled)

42. A user equipment (UE) for wireless communication, comprising:
a memory; and
one or more processors coupled to the memory and configured to:
receive a cancellation indication associated with an uplink transmission on a shared radio frequency spectrum band, the shared radio frequency spectrum band having a listen-before-talk (LBT) channel access mechanism to access the shared radio frequency spectrum band;
determine, based at least in part on the reception of the cancellation indication associated with the uplink transmission on the shared radio frequency spectrum band, whether the uplink transmission is to be cancelled or transmitted at a reduced transmit power; and
when the uplink transmission is to be transmitted at the reduced transmit power, transmit the uplink transmission at the reduced transmit power.

43. The UE of claim 42, wherein the uplink transmission is a first uplink transmission, and wherein the first uplink transmission is transmitted at the reduced transmit power based at least in part on the UE being configured to transmit a second uplink transmission subsequent to the first uplink transmission.

44. The UE of claim 43, wherein the one or more processors are further configured to:
transmit the second uplink transmission without performing an LBT operation between the first uplink transmission and the second uplink transmission.

45-60. (canceled)

61. A base station for wireless communication, comprising:
a memory; and
one or more processors coupled to the memory and configured to:
transmit, to a user equipment (UE), a cancellation indication associated with an uplink transmission on a shared radio frequency spectrum band, the shared radio frequency spectrum band having a listen-before-talk (LBT) channel access mechanism to access the shared radio frequency spectrum band; and
when the uplink transmission is to be transmitted at the reduced transmit power, receive the uplink transmission based at least in part on the reduced transmit power.

62. The base station of claim 61, wherein the uplink transmission is a first uplink transmission, and wherein the first uplink transmission is associated with the reduced transmit power based at least in part on the UE being configured to transmit a second uplink transmission subsequent to the first uplink transmission.

63. The base station of claim 61, wherein the one or more processors are further configured to determine whether the uplink transmission is to be cancelled or transmitted at the reduced transmit power based at least in part on whether the uplink transmission overlaps with another uplink transmission.

64-123. (canceled)

124. An apparatus for wireless communication, comprising:
means for receiving a cancellation indication associated with an uplink transmission on a shared radio frequency spectrum band, the shared radio frequency spectrum band having a listen-before-talk (LBT) channel access mechanism to access the shared radio frequency spectrum band;
means for determining, based at least in part on the reception of the cancellation indication associated with the uplink transmission on the shared radio frequency spectrum band, whether the uplink transmission is to be cancelled or transmitted at a reduced transmit power; and
when the uplink transmission is to be transmitted at the reduced transmit power, transmitting the uplink transmission at the reduced transmit power.

125. The apparatus of claim 124, wherein the uplink transmission is a first uplink transmission, and wherein the first uplink transmission is transmitted at the reduced transmit power based at least in part on the apparatus being configured to transmit a second uplink transmission subsequent to the first uplink transmission.

126-164. (canceled)
